(19) United States
(12) Patent Application Publication
(10) Pub. No.: US 2006/0187835 A1
(43) Pub. Date: Aug. 24, 2006

(54) Apparatus and method for adjusting adaptive service bandwidth in quality of service guaranteed network

(75) Inventors: Hong-Jin Ahn, Seoul (KR); Jin-Uk Lee, Suwon-si (KR); Dong-Kyu Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/355,962

(22) Filed: Feb. 17, 2006

(30) Foreign Application Priority Data
Feb. 18, 2005 (KR) 2005-13753

(51) Int. Cl. H04L 12/26; H04Q 7/00; H04L 12/56; H04J 1/16

(52) U.S. Cl. 370/230; 370/328; 370/412; 370/252

(57) ABSTRACT

An apparatus and method adjust an adaptive service bandwidth in a mobile communication system in which differentiated services for guaranteeing QoS are provided. Services are provided by using a bandwidth greater than an accepted reference value when resources of the network have a margin, and by using a weighted value according to a class when the network is in an overload state to efficiently transmit a packet and provide a user with optimal services.

### CLAIM OF PRIORITY

This application claims the benefit under 35 U.S.C. §119(a) from an application entitled “APPARATUS AND METHOD FOR ADJUSTING ADAPTIVE SERVICE BANDWIDTH IN QUALITY OF SERVICE GUARANTEED NETWORK” filed in the Korean Intellectual Property Office on Feb. 18, 2005 and assigned Serial No. 2005-13753, the entire contents of which are hereby incorporated herein by reference.

### BACKGROUND OF THE INVENTION

1. Field of the Invention

The present invention relates to an apparatus and method for adjusting an adaptive service bandwidth in a network that guarantees a quality of service (QoS) by providing classes of differentiated services.

2. Description of the Related Art

In the past, a conventional best-effort network was not required to provide classes of differentiated services. However, due to mixture of various levels of contents encoded on the network, and increased demand for QoS guaranteed services such as preferential transmission, guarantee of a bandwidth and so on, a network needs to be able to provide the differentiated services class. Real-time content and streaming content are examples of content for which bandwidth having a predetermined reference value or more is required in order to provide such services. Real-time content refers to service provided in real-time like video phone and video conference services. Streaming content refers to service provided in one direction such as Video On Demand (VOD). Since these contents should be provided without a delay or interruption while the service is provided, a guarantee of bandwidth having a predetermined level or more is needed to ensure adequate provision of the service. Currently, various schemes for guaranteeing QoS are under discussion. Among them, an exemplary one is differentiated services (Diff-Serv).

FIG. 1 illustrates the configuration of an ordinary Diff-Serv network.

An ordinary Diff-Serv network can be configured to have boundary routers located on the borders shared with other networks, and core routers located at the core thereof. In the Diff-Serv network, each router provides services complying with QoS classes for which the received content makes a demand on the basis of preset criteria.

A QoS processing module for applying Diff-Serv to a network will be described below with reference to FIG. 2.

FIG. 2 illustrates the configuration of a QoS processing module 200 in a boundary router, that is, in one Diff-Serv network element.

As illustrated in FIG. 2, a QoS processing module 200 includes a classifier 202, a marker 204, a meter 206, a dropper 208, a shaper 210, and a scheduler 212.

Here, the classifier 202 serves to receive a packet and to check a QoS class of the packet with reference to a header of the packet. The classifier 202 may be subdivided into a multi-field (MF) classifier and a behavior aggregate (BA) classifier depending on its location in the Diff-Serv network.

The MF classifier determines the QoS class of a packet entering into the Diff-Serv network with reference to various fields of the header of the packet. Further, the MF classifier determines the QoS class of a packet introduced from another Diff-Serv network which has a Diff-Serv class different from that of the Diff-Serv network to which the MF classifier belongs. The MF classifier is generally located at the boundary router of the Diff-Serv network. For reference, an example of connecting the Diff-Serv networks having different Diff-Serv classes includes the case where a mobile communication network supporting the Diff-Serv is connected with an Internet supporting the Diff-Serv. Hereinafter, either an Internet, which is connected through the boundary router and does not support the Diff-Serv, or another domain of Diff-Serv network having another QoS class is referred to as an “exterior network.”

The BA classifier detects the QoS class mapped to the packet of interest with reference to aDifferentiated Services Code Point (DSCP) of each packet forwarded in the Diff-Serv network. In general, the BA classifier is located at the core router of the Diff-Serv network, and supports Per-Hop Behavior (PHB).

In the boundary router of the Diff-Serv network, the marker 204 mainly serves to set the QoS class classified by the classifier 202 for a Type of Service (TOS) field of the corresponding IP packet, i.e. a DSCP field. In the core router of the Diff-Serv network, the marker 204 serves to reset the drop precedence level of a non-conforming packet when the dropper 208 selects Soft Policing.

The meter 206 measures a volume of IP packets introduced into the Diff-Serv network and forwards a result of comparing the measurements with a profile of the corresponding QoS class to the dropper 208 or shaper 210. Here, when a compared result value of a certain packet is appropriate to the QoS profile, the meter 206 sets Conforming for the packet. If not, the meter 206 sets Non-conforming for the packet. A technique used by the meter 206 may include a Token bucket technique by way of example.

The dropper 208 processes the packet with reference to the result values of the meter 206 using two techniques as follows: First, when selecting Hard Policing, the dropper 208 accepts a Conforming packet, but discards a Non-conforming packet. Second, when selecting Soft Policing, the dropper 208 accepts the Conforming packet, and accepts the Non-conforming packet having a drop precedence level adjusted by the marker 204.

The shaper 210 serves to adjust the bandwidth of an output node prior to the step of sending the packet to the scheduler 212. In other words, the shaper 212 selectively discards the packet on the basis of a load using Random Early Detection (RED) or Weighted Random Early Detection WRED) while managing a status of a queue allocated to each class. In the following step, the shaper 210 acts to forward the packet to the scheduler 212 at a fixed rate. The shaper 210 buffers the packet.

The scheduler 212 serves to forward the packet to an output port according to the order set by each class queue. A scheduling algorithm may include Round Robin RR), Weighted Round Robin WRR), Deficit Weighted Round Robin (DWRR), Priority Queuing (PQ), Weighted Fair Queuing (WFQ), and so on. The DWRR is mainly adopted in the current Internet environment, because it is easy for the DWRR to process a variable length packet.

Generally, the QoS processing module 200 constructed as set forth above is used in the boundary router. However, without the meter and dropper, the QoS processing module 200 is used in the core router.

FIGS. 3A and 3B illustrate shaping and policing, which are examples of adjusting a bandwidth in a QoS processing module, respectively.

FIG. 3A illustrates a process of adjusting a bandwidth by means of shaping. The shaping process means that the shaper 210 buffers and sends an overflow packet. When performing a shaping function, the shaper 210 preserves information on traffic that exceeds a reference value, and a target traffic rate set to adjust the bandwidth, by means of buffering. In this case, it is possible to reduce a loss of the traffic, but to give rise to transmission delay. As such, the shaping process is not suitable for real-time transmission of the traffic.

FIG. 3B illustrates a process of adjusting a bandwidth by means of policing. The policing process means that the dropper 208 discards a packet exceeding a drop precedence level. The policing process has an advantage in that there is no delay caused by packet buffering, but a disadvantage in that normal information is not forwarded due to a loss of the packet.

Such a bandwidth adjustment is not preferable for transmission of real-time and streaming contents, in particular.

Meanwhile, network resources used for providing services are not constant at all times, but may have a wide margin. For example, assuming that a user who is provided with 384 kbps guaranteed QoS service through a network wants to be provided with 500 kbps content, if the network resources have a margin, a 500 kbps bandwidth may be allocated to the user so that the user may be provided with a good quality of service. However, conventionally, even if the network resources have the margin, 116 kbps of the 500 kbps of allocated bandwidth, and correspondingly part of the 500 kbps content that exceeds 384 kbps or the preset bandwidth, are lost. Thus, the convention bandwidth adjustment is made according to a preset criterion, thereby failing to reflect the status of the network.

Thus, a need exists for an apparatus and method that can provide variable service bandwidth based on the status of a QoS guaranteed network.

### SUMMARY OF THE INVENTION

It is an objective of the present invention to provide an apparatus and method for adjusting an adaptive service bandwidth, capable of providing a variable service bandwidth based on the status of a QoS guaranteed network when services are provided through the network.

It is another objective of the present invention to provide an apparatus and method for adjusting an adaptive service bandwidth, which is suitable for transmission of real-time content or streaming content.

A first aspect of the present invention provides an apparatus for adjusting an adaptive service bandwidth in a quality of service (QoS) guaranteed network. The apparatus comprises a network status determining module for determining a status of the network, and a QoS processing module for adjusting the bandwidth using a first reference value if it is determined that the network status is in an overload state, and adjusting the bandwidth using a second reference value higher than the first reference value if it is determined that the network status is not in the overload state.

A second aspect of the present invention provides a method for adjusting an adaptive service bandwidth in a quality of service (QoS) guaranteed network. The method comprises the steps of determining a status of the network, measuring a volume of packets introduced into the network on the basis of each subscriber, setting a first reference value on the basis of a QoS class, and a second reference value on the basis of the measured volume of introduced packets, selecting the first reference value if it is determined that the network status is in an overload state, and selecting the second reference value higher than the first reference value if it is determined that the network status is not in the overload state, and adjusting the bandwidth using the selected reference values.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 illustrates the configuration of a Diff-Serv network as one example of a QoS guaranteed network;

FIG. 2 is illustrates the configuration of a Diff-Serv provider in a boundary router,

FIG. 3a illustrates a process of adjusting a bandwidth by means of shaping;

FIG. 3b illustrates a process of adjusting a bandwidth by means of policing;

FIG. 4 illustrates the configuration of an UMTS network according to an exemplary embodiment of the present invention;

FIG. 5 is a block diagram illustrating the configuration of a GGSN to which the present invention can be applied in accordance with an exemplary embodiment thereof;

FIG. 6 is a block diagram illustrating the configuration of an SGSN to which the present invention can be applied in accordance with an exemplary embodiment thereof;

FIG. 7 illustrates the configuration of a shaper according to an exemplary embodiment of the present invention;

FIG. 8A is a graph plotting results of adaptive service bandwidth adjustment according to an exemplary embodiment of the present invention;

FIG. 8B illustrates an exemplary embodiment of the present invention that is different from that illustrated in FIG. 8A, which is a graph illustrating an exemplary embodiment of the present invention in which a reference value for adjusting a bandwidth is set in two steps;

FIG. 9 is a flowchart illustrating a process of activating a function of adaptive service bandwidth adjustment according to an exemplary embodiment of the present invention;

FIG. 10 is a flowchart illustrating the operation of an apparatus for adjusting an adaptive service bandwidth in accordance with an exemplary embodiment of the present invention; and

FIG. 11 is a flowchart illustrating the operation of an apparatus for adjusting an adaptive service bandwidth in accordance with another exemplary embodiment of the present invention.

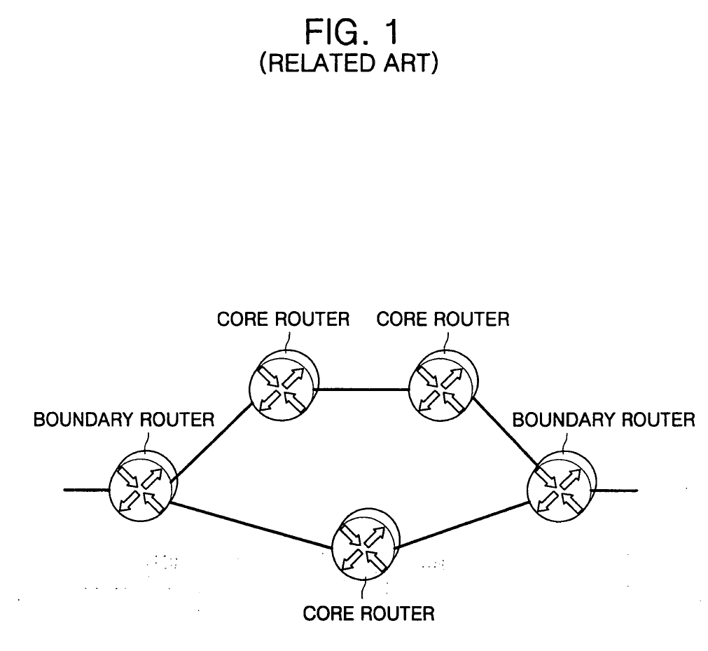

### DETAILED DESCRIPTION OF EXEMPLARY EMBODIMENTS

Hereinafter, exemplary embodiments of the present invention will be described in detail with reference to the accompanying drawings. In the following description, a detailed description of known functions and configurations incorporated herein has been omitted for conciseness. The present invention to be described below is adapted to enable a user to be provided with better services by increasing a bandwidth allocated for services when network resources have a margin. Of course, if necessary, the present invention may also be applied to decrease the service bandwidth in the overload state of a network.

Terms used for the description of the present invention are defined as follows. The term “exterior network” refers to either an Internet which is connected through any boundary router and does not support differentiated services (Diff-Serv) or another domain of Diff-Serv network having another QoS class. The term “QoS guaranteed network” refers to a network that guarantees QoS through means such as the Diff-Serv.

The following description will be made regarding exemplary embodiments in which the present invention is applied to a universal mobile telecommunication system (UMTS) network, which is connected as the exterior network and supports the Diff-Serv in order to guarantee QoS. It should be noted that the following exemplary embodiments are merely to help understanding the present invention and thus are not to be interpreted as limiting the scope of the present invention.

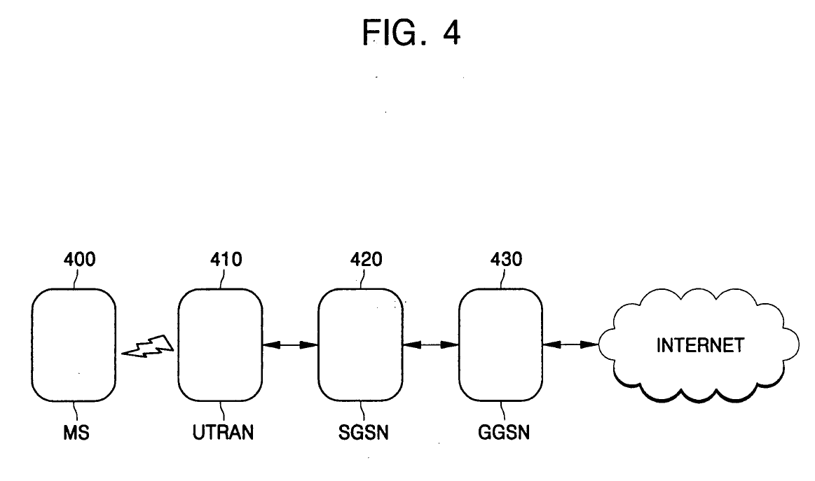

FIG. 4 illustrates the configuration of an UMTS network according to en exemplary embodiment of the present invention.

An UMTS network is composed of a mobile station (MS) 400, an UMTS terrestrial radio access network (UTRAN) 410, a serving General Packet Radio Service (GPRS) support node (SGSN) 420, and a gateway GPRS support node (GGSN) 430. In FIG. 4, the UTRAN 410 or GGSN 430 may correspond to a boundary router, and the SGSN 420 may correspond to a core router. An apparatus for adjusting an adaptive service bandwidth in accordance with the present invention can be located at the UTRAN 410, SGSN 420, or GGSN 430 of the UMTS network.

Meanwhile, a QoS guaranteed network is generally realized so as to classify QoS classes according to a quality of provided service and provide the service conforming to a corresponding QoS class. Preferably, the present invention also determines whether the service is applied according to each QoS class in a differentiated manner. Therefore, prior to the description of the apparatus for adjusting an adaptive service bandwidth in accordance with an exemplary embodiment of the present invention, the QoS classes which can be applied in the UMTS network will be described.

The QoS classes of the UMTS network can be variously set. However, the present invention will be described based on an exemplary embodiment in which the UMTS network has four QoS classes: Conversational class, Streaming class, Interactive class and Background class. See TS 23.107 for more details than the following description with respect to the QoS classes of the UMTS network.

The Conversational class is provided for services requiring real-time packet transmission, such as video conference and the like. The Conversational class permits essentially no distortion of time and minimizes delay. The Conversational class is the highest QoS class, which is provided in the UMTS network and guarantees a given bandwidth, and in which a packet is discarded in a system overload state for the last time.

The Streaming class is used for traffic for streaming service such as VOD. The Streaming class is similar to the Conversational class in that essentially no distortion of time is permitted. However, the Streaming class permits delay to a certain extent unlike the Conversational class. The Streaming class is the second QoS class which guarantees a given bandwidth, and in which a packet is selectively discarded in a system overload state.

The Interactive class is provided for services such as web browsing and so on, which generally has a request/response pattern. The Interactive class is preferably used for services which are not greatly influenced by a loss of packet. For example, the Interactive class may be used for web page service which is reconnected when abnormal loading takes place. The Interactive class is a class in which a lot of packets are discarded in a system overload state.

The Background class has the lowest QoS class of the UMTS network. It is e-mail service that is taken as the most typical service of the Background class. The Background class is characterized by a user receiving information of interest that is not regarded to be important. In other words, the Background class can be used for services insensitive to transmission time and delay of the information. The Background class is irrelevant to a loss of packet halfway. As such, most packets having the Background class are discarded in a system overload state.

Among the QoS classes, the upper two classes, that is, the Conversational and Streaming classes, are each generally classified as a guaranteed QoS class. The present invention is preferably applied by adopting a user of the guaranteed QoS class as a target. This is because the user of the guaranteed QoS class pays a fee higher than other users in order to enable a corresponding bandwidth to be guaranteed to a designated extent. Typically, network resources (e.g., bandwidth) provided for the services of this guaranteed QoS class are not infringed by sources of the other users. The services of the guaranteed QoS class are set to discard the packet less than the services of the other ordinary QoS classes (e.g., the Interactive and Background classes). Of course, applying the adaptive service bandwidth adjustment according to the present invention only to the guaranteed QoS class is merely illustrative of the exemplary embodiments of the present invention, and thus the present invention is not limited to these embodiments.

Next, configurations of the GGSN 430 and SGSN 420 to which the present invention can be applied will be described with reference to the attached drawings.

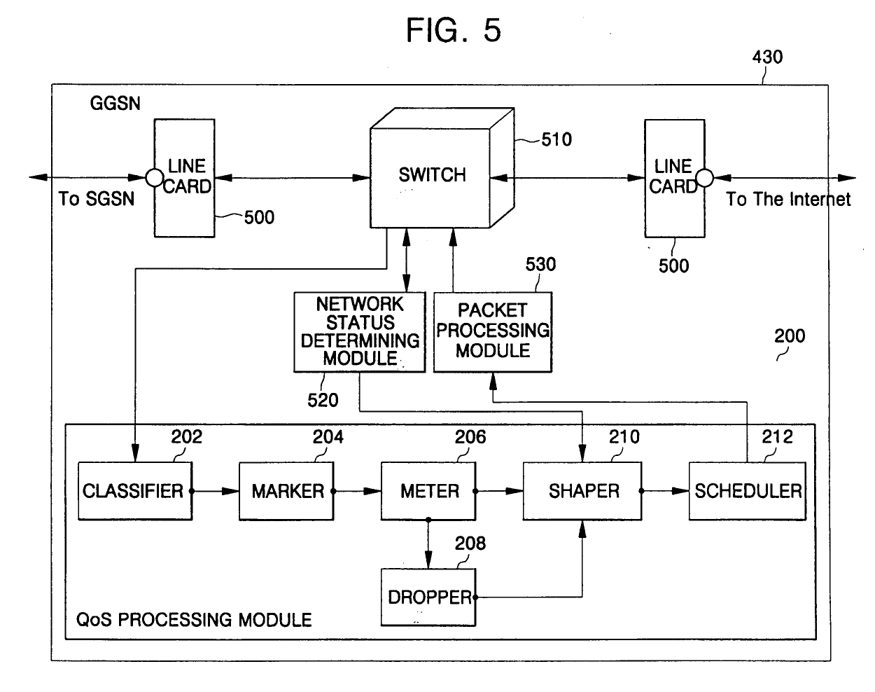

FIG. 5 is a block diagram illustrating the configuration of a GGSN to which the present invention can be applied in accordance with an exemplary embodiment.

As illustrated in FIG. 5, the GGSN 430 comprises a line card 500, a switch 510, a network status determining module 520, a packet processing module 530 and a QoS processing module 200. The GGSN 430 may operate as a boundary router in the UMTS network.

Here, the line card 500 is connected with the SGSN 420 or Internet through a physical port and transceives a packet through the physical port. At this time, the transceived packet is an IP packet. Meanwhile, the line card 500 may be connected with the SGSN 420 through a Gn interface, and Internet through a Gi interface.

The switch 510 preferably corresponds to an IP switch, and switches between the line card 500 and the packet processing module 530 so as to enable the packet to be transmitted to a correct destination. The packet received from the Internet or SGSN 420 through the line card 500 is transmitted to the packet processing module 530 through the switch 510, and then the packet processed at the packet processing module 530 is transmitted again to the SGSN 420 or Internet through the line card 500 located opposite to the line card 500 which has received the packet through the switch 510.

The packet processing module 530 processes the packet received from the Internet and the packet received from the SGSN 420 in a different way. With respect to the packet received from the Internet, the packet processing module 530 adds IP, User Datagram Protocol (UDP), and GPRS Tunneling Protocol (GTP) headers to the packet so as to enable the packet to be used in the UMTS network. With respect to the packet received from the SGSN 420, the packet processing module 530 removes IP, UDP, and GTP headers included in the packet.

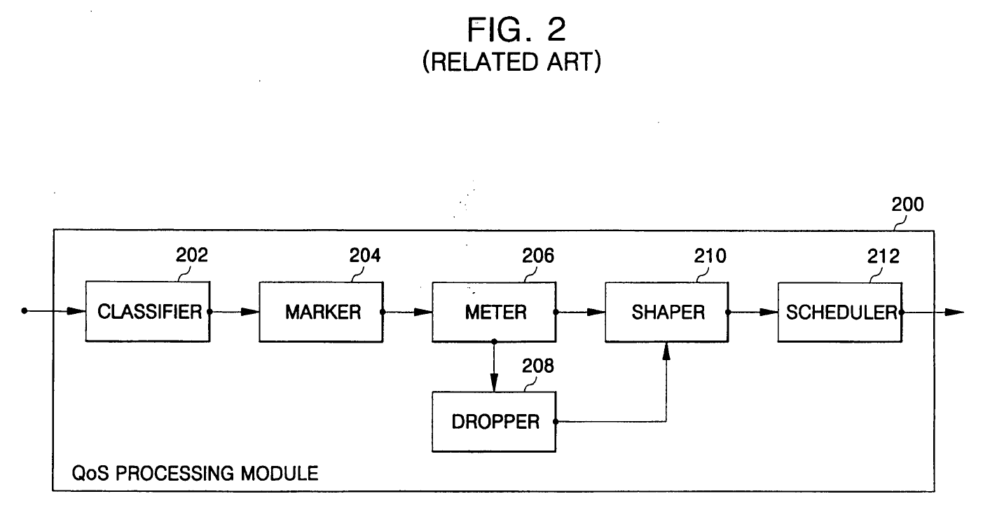

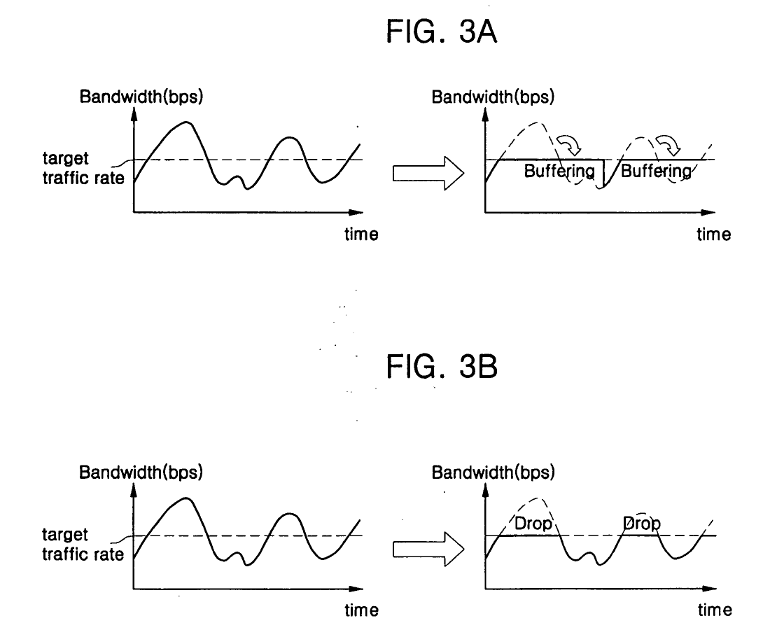

In the present invention, the packet output from the switch 510 is forwarded to the packet processing module 530 through the QoS processing module 200, which is configured for processing the packet according to the set QoS class. The QoS processing module 200 has been already described with reference to FIG. 2, the description of which is as follows.

The QoS processing module 200 comprises a classifier 202, a marker 204, a meter 206, a dropper 208, a shaper 210, and a scheduler 212.

Here, the classifier 202 serves to check the QoS class of a packet that is received from the switch 510 and introduced from an exterior network (e.g. Internet) into a Diff-Serv network with reference to a header of the packet. The marker 204 mainly serves to set the QoS class classified by the classifier 202 for a Type of Service (ToS) field of the corresponding IP packet, i.e., a Differentiated Services Code Point (DSCP) field. The meter 206 measures a volume of IP packets introduced into the Diff-Serv network and forwards a result of comparing the measurements with a profile of the corresponding QoS class to the dropper 208 or shaper 210. The dropper 208 drops or transmits the packet with reference to the result values of the meter 206. The shaper 210 serves to adjust the bandwidth of an output node prior to the step of sending the packet to the scheduler 212. The scheduler 212 serves to forward the packet to an output port according to the order set by each class queue.

The shaper 210 and dropper 208 can be used for the adaptive service bandwidth adjustment of the present invention in accordance with an exemplary embodiment. Above all, the shaper 210 that is used in both the boundary router and the core router is important. The shaper 210 will be described below in detail.

In accordance with an exemplary embodiment of the present invention, the shaper 210 adjusts the bandwidth according to a variable reference value dependent on a status of the network rather than a fixed reference value. Thus, in the present invention, variation of a reference value that the shaper 210 uses to adjust the bandwidth, and data to be used to vary the reference value, and so on are important.

First, the network status data used to vary the reference value and that the shaper 210 uses to adjust the bandwidth will now be described. The network status data represents a current state of resources (e.g., available bandwidth) that should be considered when the packet is transmitted through the network. The network status data can be collected by two methods: one method is to use the meter 206 of the QoS processing module 200, and the other method is to use the network status determining module 520.

First, the method of using the meter 206 will be described. The meter 206 measures a volume of packets introduced into the network. The meter 206 can measure a volume of packets on the basis of each channel. The total volume of packets introduced into the network is obtained by adding up all volumes of packets on the basis of each channel. Further, the volume of packets introduced into the network can be considered as an amount of resources that are used in the current network. Meanwhile, the meter 206 can measure a volume of packets on the basis of each subscriber. Usually, the channels are assigned to the subscribers, respectively. Thus, the volume of packets on the basis of each channel is conceptually equal to the volume of packets on the basis of each subscriber. It is natural that one channel is not always assigned to one subscriber. The volume of packets which the network can support is set in advance, so that a status of the current network can be detected by comparison of the volume of introduced packets with the volume of packets which the network can support. In other words, if the volume of packets introduced into the network is little, the current network may be considered to have spare resources. In contrast, if the volume of packets introduced into the network is much, the current network may be considered to be in an overload state. When the network has spare resources, the shaper 210 increases the reference value for the bandwidth adjustment to increase the bandwidth for the provided services. Thus, the delay or loss of the packet does not take place. Meanwhile, the meter 206 can measure a peak value of the volume of the introduced packets and outputs the measurement to the shaper 210. Here, if the shaper 210 sets the reference values to the peak value of the volume of the packets, the delay or loss of the packet can be completely prevented. Therefore, when there are many resources available in the network, setting the reference value for the bandwidth adjustment to the peak value of the volume of the packets is preferable for the purpose of efficient transmission of the packets. Herein, the present invention has been described according to an exemplary embodiment in which the shaper 210 sets the reference value to be used for adjusting bandwidth. However, the present invention can be realized in such a manner that the functions of setting the reference value and adjusting the bandwidth are performed by different components. For example, the present invention may be adapted to have a marker for setting the reference value, and a shaper for adjusting the bandwidth using the reference value set by the marker.

Next, a method of using the network status determining module 520 will be described. The network status determining module 520 is also used to collect the network status data. In contrast with the meter 206, which merely measures the volume of the introduced packets, the network status determining module 520 can collect the network status data using analysis of more factors such as the number of set sessions, processability of the system, and so on. As a result, the network status determining module 520 can determine whether the current network has a spare resource or is in an overload state by comparing the measurements with a predetermined reference value, and output the compared result value to the shaper 210. Setting the reference value for the bandwidth adjustment and adjusting the bandwidth in the shaper 210 are the same as stated above. When the reference value for the bandwidth adjustment is set, a peak value of the volume of packets that can be received from the meter 206 can be taken into consideration.

Meanwhile, the dropper 208 can also adjust the adaptive service bandwidth using a method similar to that of the shaper 210. That is, the dropper 208 receives network status data from the meter 206 or network status determining module 520, and adjusts a reference value, a drop precedence level value of dropping the packet using a value of the received data.

In other words, the adaptive service bandwidth adjusting apparatus according to an exemplary embodiment of the present invention essentially comprises the meter 206 and shaper 210, or the meter 206 and dropper 208.

Meanwhile, both or one of the shaper 210 and dropper 208 can be set to adjust the adaptive service bandwidth. These modifications can be included within the scope of the present invention.

A configuration of the SGSN 420 operating as the core router in the UMTS network in accordance with an exemplary embodiment will be described.

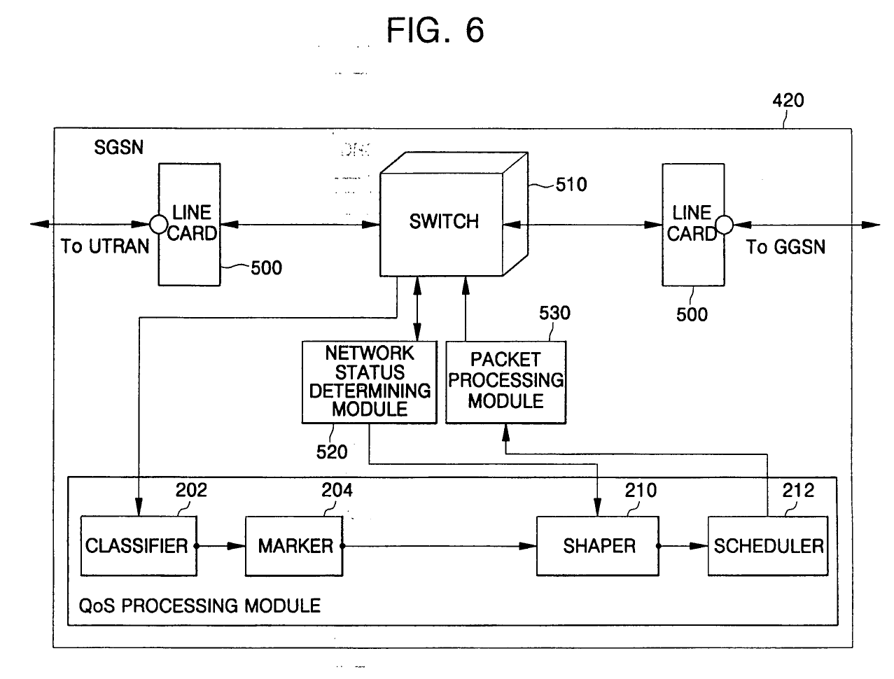

FIG. 6 is a block diagram illustrating the configuration of an SGSN to which the present invention can be applied in accordance with an exemplary embodiment.

Here, a line card 500 is connected with an UTRAN 410 or GGSN 430 through a physical port and transceives a packet through the physical port. The line card 500 may be connected with the UTRAN 410 through an Iu interface, and with the GGSN 430 through a Gn interface. The SGSN is not a boundary router, but a core router. Thus, a packet processing module 530 of the SGSN serves to modify values of source and destination IP addresses of IP and GTP headers of a received packet, and a value of a tunnel endpoint identifier (TEID), and forwards the modified packet to the corresponding interface. A switch 510 of the SGSN 420 is functionally the same as that of the GGSN 430.

A QoS processing module 200 of the SGSN 420 is generally not provided with a meter 206 and a dropper 208 because the SGSN 420, the core router, has only to perform the Per Hop Behavior (PHB). With respect to the other constituents, the QoS processing module 200 of the SGSN 420 is similar to that of the GGSN 430.

Meanwhile, the UTRAN 410 of FIG. 4 also has a configuration for application of the present invention like the GGSN 430 and SGSN 420 in accordance with another exemplary embodiment. The UTRAN 410 operates as a boundary router like the GGSN 430, and has a QoS processing module configured similar to that of the GGSN 430. Hence, a description of the configuration of the UTRAN 410 is omitted for conciseness. Meanwhile, it should be noted that descriptions of functions of the UTRAN 410, SGSN 420 and GGSN 430 that not relevant to the functions associated with the present invention, such as a communication function and the like, are also omitted for conciseness.

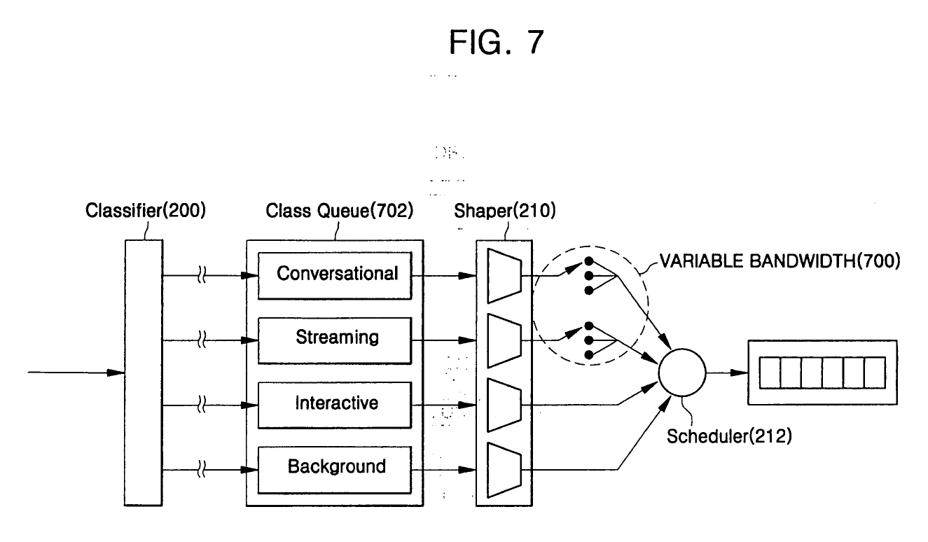

FIG. 7 illustrates the configuration of a shaper according to an exemplary embodiment of the present invention.

As illustrated in FIG. 7, a shaper 210 has queues according to each QoS class. Packets input into a QoS processing module 200 are classified at a classifier 202, and the classified packets are output to the corresponding queues 702 according to each QoS class. As illustrated in FIG. 7, the shaper 210 can apply the adaptive service bandwidth adjustment, which varies a shaping reference value according to a network status, only to the packets having the guaranteed QoS classes, the Conventional and Streaming classes. FIG. 7 illustrates an embodiment in which the shaper 210 performs shaping on the packets having the Conventional and Streaming classes using three steps of reference values according to the network status. Of course, a step of varying the reference value may be variously set according to a characteristic of the system, for example, in two steps, four steps, and so on, instead of the three steps illustrated in FIG. 7. In the case where the reference value is to be classified into three or more steps, a plurality of compared reference values are needed to classify the network status into a plurality of classes based on the total volume of introduced packets.

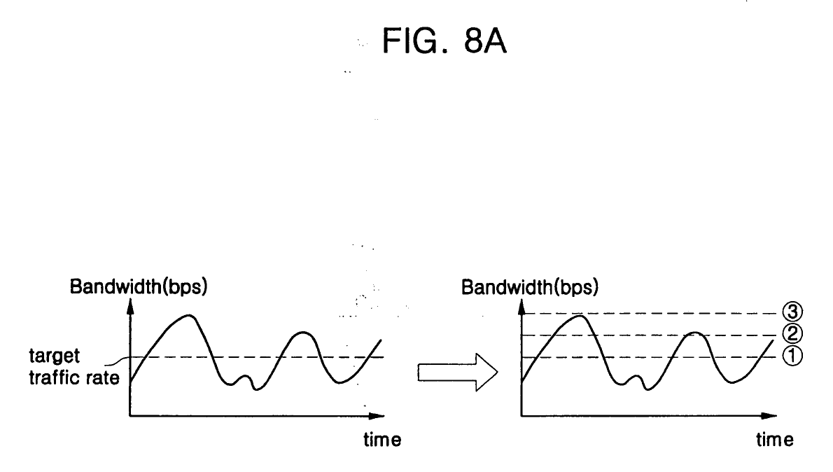

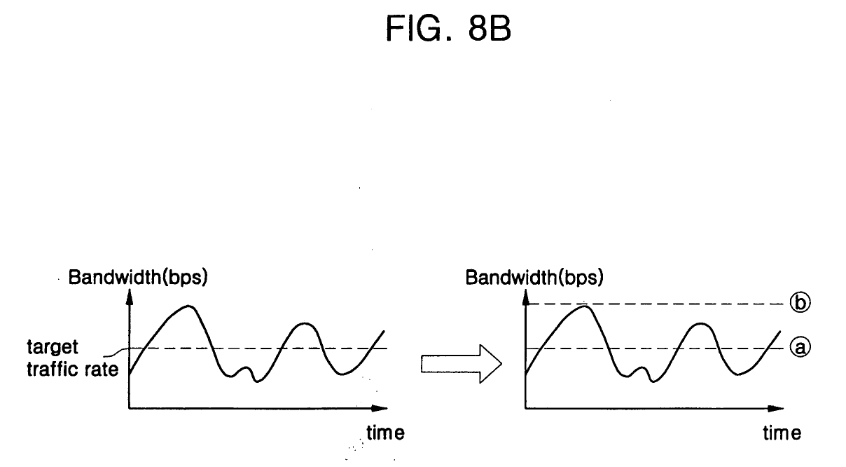

FIG. 8A is a graph plotting results of adaptive service bandwidth adjustment according to an exemplary embodiment of the present invention.

In particular, FIG. 8A is a graph illustrating an embodiment in which a reference value for adjusting a bandwidth is set in three steps. In FIG. 8A, symbol \textcircled{1} refers to an existing reference value, a target traffic rate or drop precedence level, and symbol \textcircled{3} refers to a modified target traffic rate that is to be accepted potentially. Generally, the value corresponding to symbol \textcircled{1} may be set on the basis of a QoS class. A value of symbol \textcircled{3} is preferably set to a value more than the peak value of a volume of packets which the meter 206 measures. The set value is varied according to an inflow of traffic. Symbol \textcircled{2} indicates a value set to minimize buffering of the packet in the overload state. However, it is preferable to comply with existing QoS setting in the overload state. The value of symbol \textcircled{1} may be regarded as a first reference value, the value of symbol \textcircled{2} as a second reference value, and the value of symbol \textcircled{3} as a third reference value.

FIG. 8B illustrates an embodiment different from that illustrated in FIG. 8A. FIG. 8B is a graph illustrating an exemplary embodiment of the present invention in which a reference value for adjusting a bandwidth is set in two steps.

In FIG. 8B, symbol \textcircled{a} refers to an existing reference value, a target traffic rate or drop precedence level, and symbol \textcircled{b} refers to a modified target traffic rate that is to be accepted potentially. The value of symbol \textcircled{b} may be set equal to the value of symbol \textcircled{3} in FIG. 8A. In the embodiment illustrated in FIG. 8B, because only reference values of two steps are used, the value of symbol \textcircled{a} is used as the reference value in the overload state. Here, the value of symbol \textcircled{a} can be regarded as a first reference value, and the value of symbol \textcircled{b} as a second reference value.

Meanwhile, the adaptive service bandwidth adjustment according to the present invention is preferably determined whether or not it is applied according to existence or non-existence of the Interactive and Background classes and an overload grade of the network.

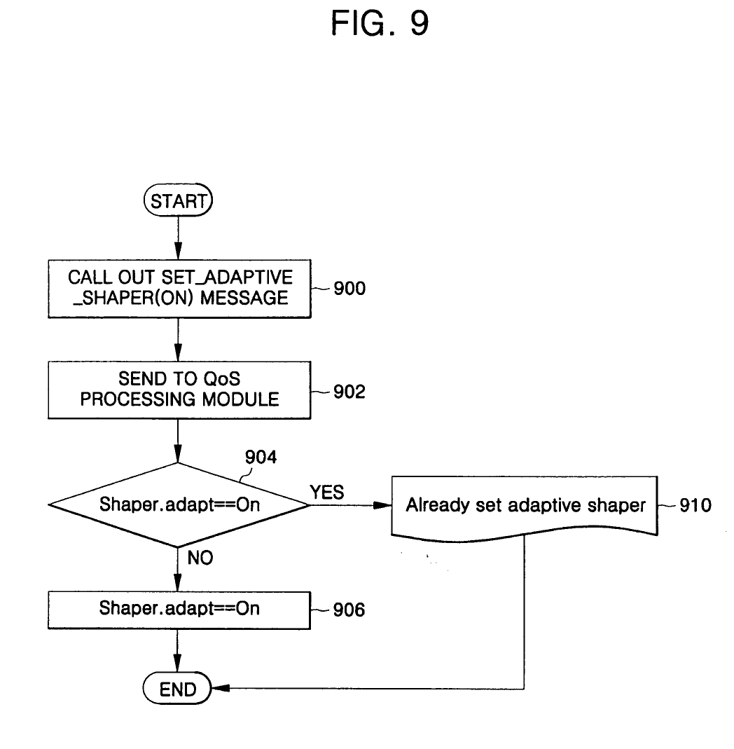

Hereinafter, processes for the adaptive service bandwidth adjustment according to an exemplary embodiment of the present invention will be described with reference to FIG. 9.

FIG. 9 is a flowchart illustrating a process of activating a function of adaptive service bandwidth adjustment according to an exemplary embodiment of the present invention.

In general, a function of adaptive service bandwidth adjustment can be activated or inactivated through Command Line Interface (CLI) manipulation of a network's operator. Each step illustrated in FIG. 9 is like being described below. The exemplary embodiment illustrated in FIG. 9 is merely illustrative to help understanding the present invention, and this is not to be interpreted as limiting the scope of the present invention.

A process of activating a function of adaptive service bandwidth adjustment is initiated. In step S900, a Set_adaptive_shaper(On) message is called out through a CLI command. In step S902, the Set_adaptive_shaper(On) message is sent to the QoS processing module 200. In step S904, it is determined whether the function of adaptive service bandwidth adjustment according to the present invention has been already activated in the network or not. This determination is carried out by checking the value of a Shaper adapt parameter. If the function of adaptive service bandwidth adjustment is not activated, the function of adaptive service bandwidth adjustment is activated in step S906.

Next, a process for adjusting adaptive service bandwidth in accordance with the present invention will be described.

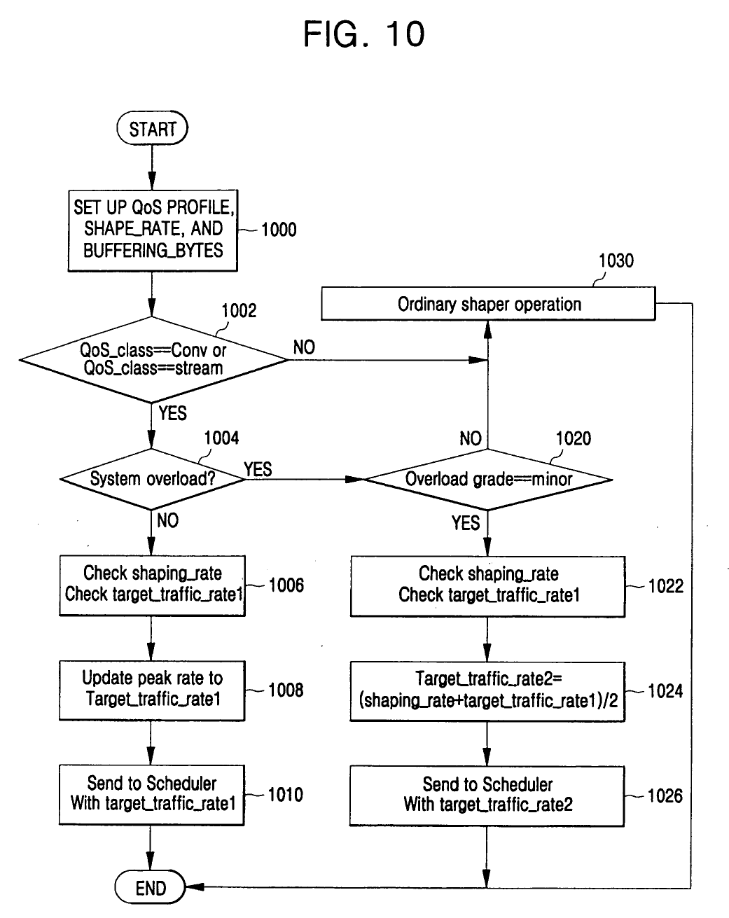

FIG. 10 is a flowchart illustrating the operation of an apparatus for adjusting an adaptive service bandwidth in accordance with an exemplary embodiment of the present invention.

The embodiment illustrated in FIG. 10 is merely illustrative to help understanding the present invention, and is not to be interpreted as limiting the scope of the present invention.

In step S1000, an apparatus for adjusting an adaptive service bandwidth in accordance with the present invention sets a QoS profile in order to use a QoS function. Typically, a point of time t at which the QoS profile is set is a system initial driving point of time, because it is very rare to set the QoS profile during operation of the system.

In step S1002, the QoS class of a channel of which a received packet makes use is determined, and it is determined whether the QoS class of the corresponding channel is a guaranteed QoS class (e.g., a Conversational or Streaming class) or not. If the received packet belongs to the guaranteed QoS class, the process proceeds to step S1004. If the received packet does not belong to the guaranteed QoS class, a function of adjusting the adaptive service bandwidth is not preformed. In step S1004, a status of the network is determined at this point of time. If it is determined that the network is not in an overload state, the process proceeds to step S1006. In contrast, if it is determined that the network is in an overload state, the process proceeds to step S1020.

In step S1006, a set reference value for bandwidth adjustment is determined. In step S1008, a peak value of the volume of received packets is set to a new reference value for the bandwidth adjustment. In step S1010, the bandwidth adjustment such as shaping or policing is performed using the new reference value set in step S1008.

In step S1020, it is determined to what grade the overload state of the network has. If it is determined that the overload state of the network meets a preset reference value, the reference value for the bandwidth adjustment corresponding to the status of the network is varied (e.g., a new target rate is determined by averaging the shaping rate and the current traffic rate). The processes for this variation correspond to steps S1022 to S1026.

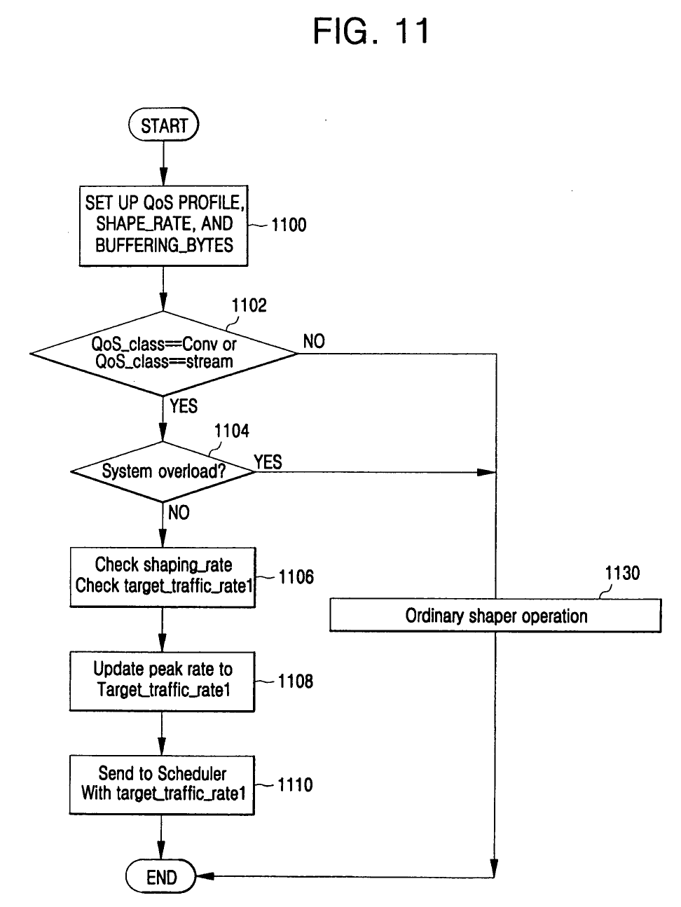

FIG. 11 is a flowchart illustrating the operation of an apparatus for adjusting an adaptive service bandwidth in accordance with another exemplary embodiment of the present invention.

FIG. 11 illustrates an exemplary embodiment of the present invention in which a service bandwidth is adjusted using a reference value classified into two steps, unlike the embodiment of FIG. 10 in which the service bandwidth is adjusted using the reference value classified into three steps. Steps S1100 to S1110 of FIG. 11 are similar to steps S1000 to S1010 of FIG. 10.

In step S1100 of FIG. 11, an apparatus for adjusting an adaptive service bandwidth in accordance with the present invention sets a QoS profile in order to use a QoS function. As stated above, a point of time at which the QoS profile is set generally is a system initial driving point of time.

In step S1102, the QoS class of a channel of which a received packet makes use is determined, and it is determined whether the QoS class of the corresponding channel is a guaranteed QoS class (e.g., a Conversational or Streaming class) or not. If the received packet belongs to the guaranteed QoS class, the process proceeds to step S1104. If the received packet does not belong to the guaranteed QoS class, a function of adjusting the adaptive service bandwidth is not preformed. That is, the process proceeds to step S1130.

In step S1104, a status of the network is determined at this point of time. If it is determined that the network is not in an overload state, the process proceeds to step S1106. In contrast, if it is determined that the network is in an overload state, the process proceeds to step S1130.

In step S1106, a set reference value for bandwidth adjustment is determined. In step S1108, a peak value of the volume of received packets is set to a new reference value for the bandwidth adjustment. In step S1110, the bandwidth adjustment such as shaping or policing is performed using the new reference value set in step S1008.

In the present invention as set forth above, the function of adjusting the adaptive service bandwidth is performed, and an extra bandwidth is permitted in the shaper. This function should be considered in cooperation with an accounting policy, and preferably only those users who require this function should be serviced.

As can be seen from the foregoing, with the application of the present invention, it is possible to adjust the service bandwidth based on the status of the network. As a result, the transmission delay, or discarding of the packet which may take place during transmission of the packet, are reduced. Due to the reduction of the transmission delay or discarding of the packet, it is possible to efficiently transmit the real-time content and streaming content.

While the present invention has been described with reference to exemplary embodiments thereof, it will be understood by those skilled in the art that various changes in from and detail may be made therein without departing from the scope of the present invention as defined by the following claims

What is claimed is:

1. An apparatus for adjusting an adaptive service bandwidth in a quality of service (QoS) guaranteed network, comprising:
a network status determining module for determining a status of the network; and
a QoS processing module for adjusting the bandwidth using a first reference value if it is determined that the network status is in an overload state, and adjusting the bandwidth using a second reference value higher than the first reference value if it is determined that the network status is not in the overload state.

2. The apparatus of claim 1, wherein the QoS processing module comprises:
a marker for setting the first and second reference values; and
a shaper for adjusting the bandwidth using the set first and second reference values.

3. The apparatus of claim 1, wherein the first reference value is a value corresponding to a preset QoS class.

4. The apparatus of claim 3, further comprising a meter for measuring a volume of introduced packets on the basis of each subscriber,
wherein the shaper sets the second reference value according to the measured volume of introduced packets.

5. The apparatus of claim 4, wherein the shaper sets a peak value of the measured volume of introduced packets to the second reference value.

6. The apparatus of claim 1, wherein the QoS processing module:
compares an amount of resources used in the network with a predetermined comparison reference value if it is determined that the network is in the overload state; and
adjusts the bandwidth using the first reference value if the amount of resources used in the network is more than the predetermined comparison reference value, and adjust the bandwidth using a third reference value between the first and second reference values if the amount of resources used in the network is less than the predetermined comparison reference value.

7. The apparatus of claim 6, wherein the third reference value is a mean value between the first and second reference values.

8. The apparatus of claim 6, wherein:
the predetermined comparison reference value comprises a plurality of values capable of classifying the amount of resources used in the network into a plurality of classes; and
the third reference value comprises a plurality of reference values set to correspond to each of the classes.

9. The apparatus of claim 1, wherein the QoS processing module varies the reference value only for at least one packet of a guaranteed QoS class.

10. The apparatus of claim 9, wherein the QoS processing module comprises queues based on QoS classes supported in the network, queues each received packet to a corresponding queue, and varies the reference value only for the queue for the at least one packet of the guaranteed QoS class.

11. The apparatus of claim 1, wherein the QoS guaranteed network is a universal mobile telecommunication system (UMTS) network in which differentiated services (Diff-Serv) are supported.

12. The apparatus of claim 1, wherein the QoS processing module adjusts the bandwidth by performing policing or shaping processing on at least one input packet using the set reference value.

13. A method for adjusting an adaptive service bandwidth in a quality of service (QoS) guaranteed network, comprising the steps of:
determining a status of the network;
measuring a volume of packets introduced into the network on the basis of each subscriber;
setting a first reference value on the basis of a QoS class, and a second reference value on the basis of the measured volume of introduced packets;
selecting the first reference value if it is determined that the network status is in an overload state, and selecting the second reference value higher than the first reference value if it is determined that the network status is not in the overload state; and
adjusting the bandwidth using the selected reference values.

14. The method of claim 13, wherein the step of setting the reference values comprises the step of setting the second reference value to a peak value of the volume of introduced packets.

15. The method of claim 13, wherein the step of determining a status of the network comprises the steps of:
measuring an amount of resources used in the network; and
comparing the measured amount of resources with the total amount of resources provided by the network, determining the network to be in the overload state if the measured amount of resources is more than the total amount of resources provided by the network, and determining the network not to be in the overload state if the measured amount of resources is less than the total amount of resources provided by the network.

16. The method of claim 15, further comprising the steps of:
comparing the measured amount of resources with a predetermined value if it is determined that the network is in the overload state; and
selecting the first reference value if the measured amount of resources is more than the predetermined value, and selecting a third reference value between the first and second reference values if the measured amount of resources is less than the predetermined value.

17. The method of claim 13, wherein the step of adjusting the bandwidth using the selected reference values comprises the step of performing policing or shaping processing on the input packets using the selected reference values.
